(19) United States
(12) Patent Application Publication
(10) Pub. No.: US 2002/0091735 A1
(43) Pub. Date: Jul. 11, 2002

(54) Method and apparatus for locating geographically classified establishment information

(75) Inventor: Kuan-Chang Chen, Kaohsiung City (TW)

Correspondence Address: BRINKS HOFER GILSON & LIONE, NBC Tower - Suite 3600, 455 N. Cityfront Plaza Drive, Chicago, IL, 60611-5599, US

(73) Assignee: Yung-Chung CHEN.

(21) Appl. No.: 09/757,286

(22) Filed: Jan. 8, 2001

(51) Int. Cl. G06F 15/16; G06F 17/00

(52) U.S. Cl. 707/513; 709/217

(57) ABSTRACT

To facilitate location of establishment information, road map files are stored in a first memory, whereas establishment data for each of a plurality of establishments that are located in any of the road map files are stored in a second memory. The establishment data are classified geographically and include map location data that define a location of the corresponding establishment in any of the road map files. A third memory stores an establishment tag command for each of the establishments. A first processing unit receives a road map request from a user terminal. A second processing unit generates road map HTML that is provided to the user terminal so as that the latter can display a selected road map file according to the road map request and, if any one of the establishment data is encompassed by the selected road map file, so that the user terminal can display an index point at the location defined by the map location data of the encompassed establishment data. The road map HTML further enables the user terminal to issue an establishment tag request upon detection that a cursor has been resting over one of the index points displayed thereon. A third processing unit generates establishment tag HTML that is provided to the user terminal so that the user terminal can execute the establishment tag command corresponding to the establishment tag request.

### BACKGROUND OF THE INVENTION

1. Field of the Invention

The invention relates to a computer network, more particularly to a method and apparatus for locating geographically classified establishment information.

2. Description of the Related Art

The past several years have seen an explosive growth of the internet as an important tool for information access. In a conventional system for accessing information over the internet, a user terminal initially establishes a connection with a local internet host server via a telephone network through the use of a modem. By means of a commercially available browser program executing in the user terminal, the user can select a web page stored in a memory device of a network of server computers. In response to an http request that includes Uniform Resource Locator (URL) of the selected web page from the user terminal, the host server transmits Hypertext Markup Language (HTML) to the user terminal in order to enable the latter to show the selected web page on a display device thereof.

Presently, there exist many web sites that offer search engine services. When the main web page of a search engine site is accessed, the user terminal is operated to input a desired search parameter. In response to the search request from the user terminal, the search engine of the web site is executed to search its database, and the host server provides the search results to the user terminal for display thereon in a tabular format. The search results act as links to other web sites that comply with the desired search parameter. Thus, the user can be directed to another web site by using a mouse to point and click on one of the search results.

Currently, the contents of databases used by search engines are primarily only topically organized. As such, aside from difficulty in maintaining and classifying the contents of large databases, the accuracy of the search results can hardly be ensured due to inadequacies in the organization of the databases.

In addition, because the search results are presented in a tabular format, the user is required to frequently move back and forth between the search results page and the web page corresponding to a selected one of the search results during web browsing. Most of the time of the computer user is thus spent in moving among web pages and not in the browsing of information.

Furthermore, it is known in the art to abbreviate the information presented on a web page in order to save space and produce better layouts. With the presentation of the web page in an abbreviated format, much information can be squeezed into a browser window while minimizing the need for the user to scroll the window.

One way of abbreviating the information presented on a web page is through the use of index tags. When a cursor of the user terminal has rested over an indexed area (such as one of the search results obtained from a search engine site) of the browser window for a predetermined time period, a corresponding index tag is executed by the user terminal so that appropriate index information, such as text or images, can be displayed accordingly. It is noted that the download time for a web page depends on the amount of information thereon. The larger the amount of information, the longer will be the amount of time needed to transmit the entire HTML for the web page. Because the index information is transmitted simultaneously with the web page HTML, the download time will be longer, thereby discouraging frequent access of the web page by computer users. To reduce the transmission time, designers of web pages try to avoid the use of a large amount of image files. However, text-based web pages lack variety and are unappealing to computer users. This condition is particularly evident when the web page is directed to travel guides and the like.

### SUMMARY OF THE INVENTION

Therefore, the main object of the present invention is to provide a method and apparatus for locating geographically classified establishment information, wherein search results are shown as indexed map regions in order to overcome the aforesaid drawbacks that are commonly associated with the prior art.

According to one aspect of the invention, a method for locating geographically classified establishment information, comprises the steps of:

providing a first memory for storing road map files;

providing a second memory for storing establishment data for each of a plurality of establishments that are located in any one of the road map files in the first memory, the establishment data being classified geographically and including map location data that define a location of the corresponding establishment in said any one of the road map files in the first memory;

providing a third memory for storing an establishment tag command for each of the establishments;

in response to a road map request from a user terminal, generating road map HTML that is provided to the user terminal so as to enable the user terminal to display a selected one of the road map files in the first memory corresponding to the road map request and, if any one of the establishment data is encompassed by the selected one of the road map files, to further enable the user terminal to display an index point at the location defined by the map location data of said any one of the establishment data in the selected one of the road map files, the road map HTML further enabling the user terminal to issue an establishment tag request upon detection that a cursor of the user terminal has been resting over any one of the index points displayed thereon for a predetermined time period; and

in response to the establishment tag request, generating establishment tag HTML that is provided to the user terminal so as to enable the user terminal to execute the establishment tag command corresponding to the establishment tag request, and to terminate execution of the establishment tag command when the cursor is removed from said any one of the index points.

According to another aspect of the invention, an apparatus for locating geographically classified establishment information comprises:

a first memory for storing road map files;

a second memory for storing establishment data for each of a plurality of establishments that are located in any one of the road map files in the first memory, the establishment data being classified geographically and including map location data that define a location of the corresponding establishment in said any one of the road map files in the first memory;

a third memory for storing an establishment tag command for each of the establishments;

a first processing unit adapted to receive a road map request from a user terminal;

a second processing unit adapted to generate road map HTML that is provided to the user terminal so as to enable the user terminal to display a selected one of the road map files in the first memory corresponding to the road map request and, if any one of the establishment data is encompassed by the selected one of the road map files, to further enable the user terminal to display an index point at the location defined by the map location data of said any one of the establishment data in the selected one of the road map files, the road map HTML further enabling the user terminal to issue an establishment tag request to be received by the first processing unit upon detection that a cursor of the user terminal has been resting over any one of the index points displayed thereon for a predetermined time period; and

a third processing unit adapted to generate establishment tag HTML that is provided to the user terminal so as to enable the user terminal to execute the establishment tag command corresponding to the establishment tag request, and to terminate execution of the establishment tag command when the cursor is removed from said any one of the index points.

### BRIEF DESCRIPTION OF THE DRAWINGS

Other features and advantages of the present invention will become apparent in the following detailed description of the preferred embodiment with reference to the accompanying drawings, of which:

FIG. 1 is a simplified schematic block diagram of a computer network that implements the preferred embodiment of a method and apparatus for locating geographically classified information according to this invention;

FIG. 2 illustrates a flowchart of the method of the preferred embodiment;

FIG. 3 illustrates an image shown on a user terminal upon receipt of road map HTML in accordance with the method and apparatus of the preferred embodiment;

FIG. 4 illustrates another image shown on the user terminal upon receipt of establishment tag HTML in accordance with the method and apparatus of the preferred embodiment;

FIG. 5 is a flowchart illustrating how the preferred embodiment enables the user terminal to issue a road map request in accordance with the method and apparatus of the preferred embodiment;

FIG. 6 illustrates an image shown on the user terminal upon receipt of city map HTML and district tag HTML in accordance with the method and apparatus of the preferred embodiment;

FIG. 7 is a flowchart illustrating how the preferred embodiment enables the user terminal to issue a city map request in accordance with the method and apparatus of the preferred embodiment; and

FIG. 8 illustrates an image shown on the user terminal upon receipt of state map HTML and city tag HTML in accordance with the method and apparatus of the preferred embodiment.

### DETAILED DESCRIPTION OF THE PREFERRED EMBODIMENT

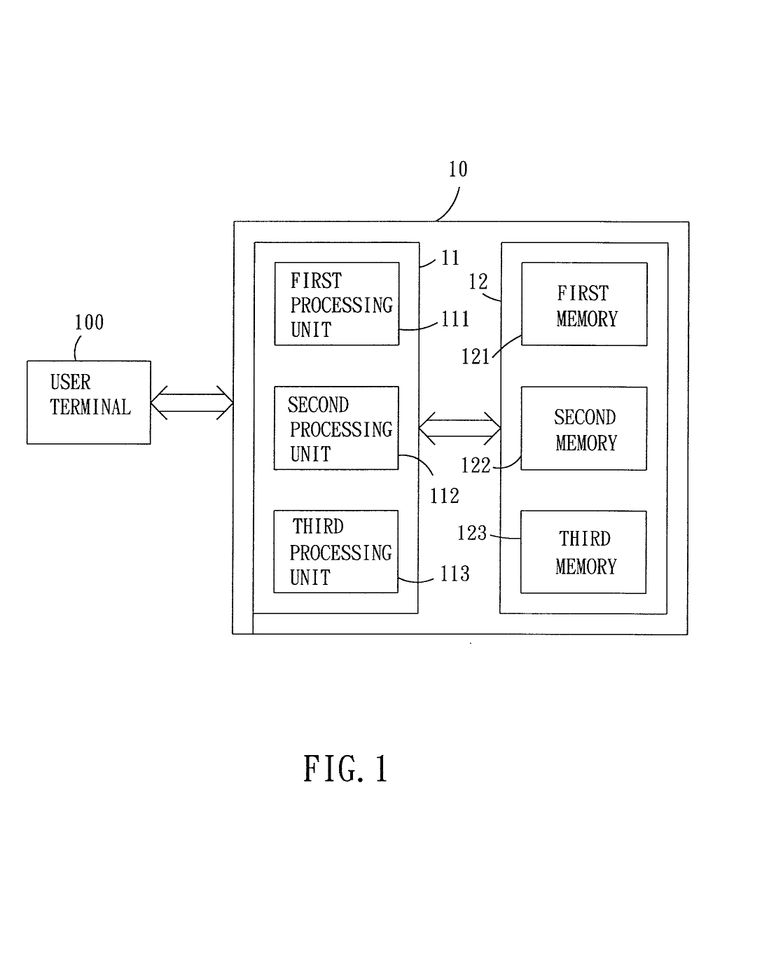

FIG. 1 is a simplified schematic block diagram of a computer network 10 that implements the preferred embodiment of a method and apparatus for locating geographically classified information according to this invention. The computer network is accessible to a plurality of user terminals 100 (only one is shown). When it is desired to access information available on the internet, a connection is initially established between the computer network 10 and the user terminal 100 through the use of a modem (not shown) in a conventional manner.

In the preferred embodiment, when a commercially available browser program is executing in the user terminal 100, the user can access a predetermined web site in a conventional manner by sending an http request that includes Uniform Resource Locator (URL) of the web site to the computer network 10. In response to the http request, the computer network 10 transmits Hypertext Markup Language (HTML) to the user terminal 100 in order to enable the latter to show a web page of the web site thereon.

According to the present invention, the computer network 10 includes a processing portion 11 and a memory portion 12. The processing portion 11 includes first, second and third processing units 111, 112, 113. The memory portion 12 includes first, second and third memories 121, 122, 123. The first memory 121 is used to store road map files. The second memory 122 is used to store establishment data for each of a plurality of establishments that are located in any one of the road map files in the first memory 121. The establishment data are classified geographically, and include map location data that define a location of the corresponding establishment in said any one of the road map files in the first memory 121. The third memory 123 is used to store an establishment tag command for each of the establishments.

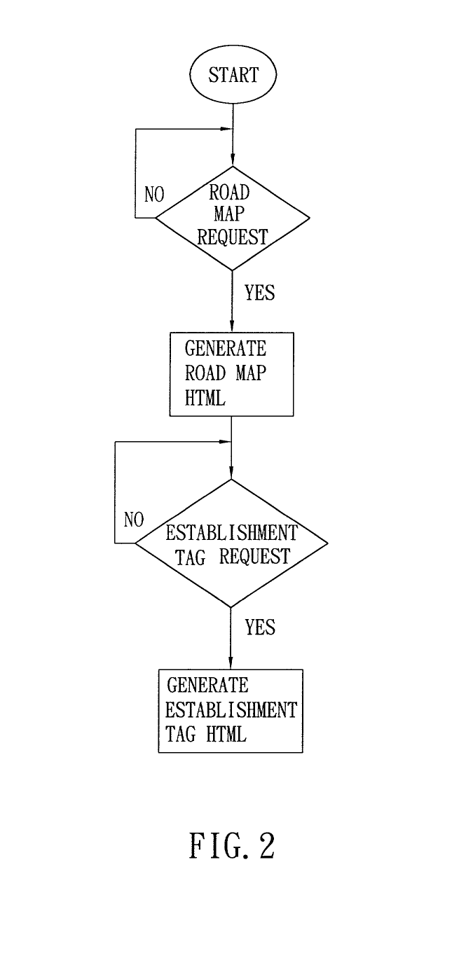

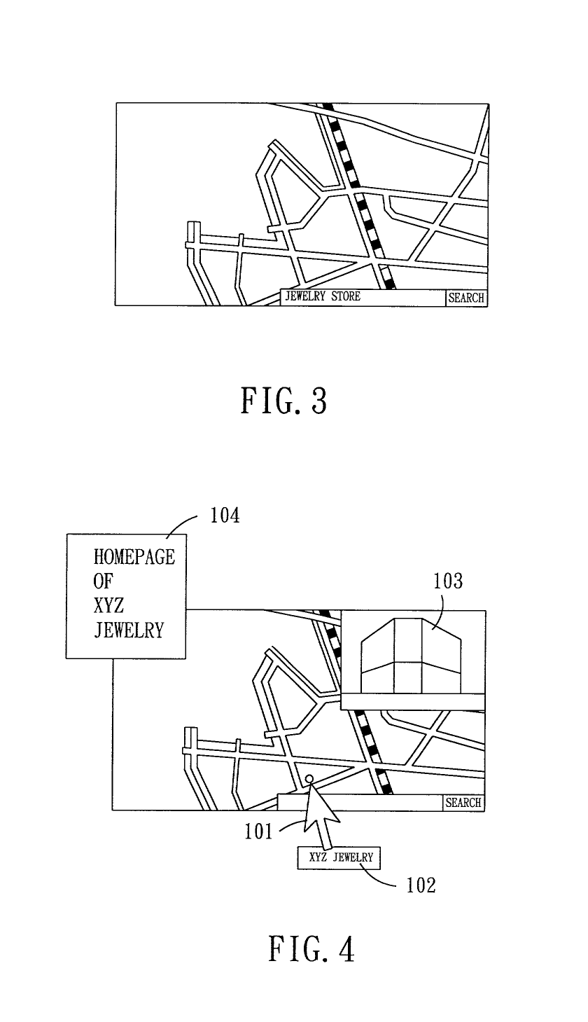

FIG. 2 is a flowchart of the method of the preferred embodiment. With reference to FIGS. 1 and 2, the first processing unit 111 initially receives a road map request from the user terminal 100. Thereafter, the second processing unit 112 generates road map HTML that is provided to the user terminal 100 so as to enable the latter to display a selected one of the road map files in the first memory 121 in response to the road map request. If any one of the establishment data is encompassed by the selected one of the road map files, the road map HTML further enables the user terminal 100 to display an index point at the location defined by the map location data of said any one of the establishment data in the selected one of the road map files. FIG. 3 illustrates the image shown on the user terminal 100 upon receipt of the road map HTML for Ling-Ya district in Kaoshiung City, Taiwan, R.O.C.

Referring once again to FIG. 1, in the preferred embodiment, the establishment data in the second memory 122 are further classified into topics according to the type of service offered by the corresponding establishment. The first processing unit 111 is further adapted to receive a topic search request from the user terminal 100, such as by inputting a search parameter. Under such a condition, the road map HTML generated by the second processing unit 112 further enables the user terminal 100 to display the index point at the location defined by the map location data of said any one of the establishment data that is encompassed by both the selected one of the road map files and the topic defined by the topic search request, thus limiting the number of index points shown by the user terminal 100. When the name of the establishment is known, it can be used as the search parameter directly. In FIG. 3, when the topic search request is “jewelry store,” the index points on the image shown on the user terminal 100 denote establishment data that are encompassed by both the “Ling-Ya district” and “jewelry store” parameters.

For large and complex road map files, it should be understood that it is within the contemplation of one skilled in the art to employ conventional zoom techniques for magnifying a desired section of the selected road map file.

Referring once again to FIGS. 1 and 2, the road map HTML generated by the second processing unit 112 further enables the user terminal 100 to issue an establishment tag request to be received by the first processing unit 111 upon detection that a cursor of the user terminal 100 has been resting over any one of the index points displayed thereon for a predetermined time period. Therefore, upon receipt by the first processing unit 111 of the establishment tag request from the user terminal 100, the third processing unit 113 generates establishment tag HTML that is provided to the user terminal 100 so as to enable the latter to execute the establishment tag command corresponding to the establishment tag request, and to terminate execution of the establishment tag command when the cursor is removed from said any one of the index points.

In the road map file of FIG. 3, when the cursor 101 (see FIG. 4) of the user terminal 100 has been resting over the index point corresponding to “XYZ Jewelry” for the predetermined time period, the establishment tag HTML that is generated by the third processing unit 113 (see FIG. 1) in response to the establishment tag request from the user terminal 100 (see FIG. 1) enables the user terminal 100 to execute the establishment tag command for displaying establishment information of “XYZ Jewelry”. Particularly, the establishment information presents the user with introductory information associated with the selected establishment, and can be a static or dynamic (scrolling) text file 102 of bibliographic content, or an image file 103. Moreover, the establishment tag HTML that is generated by the third processing unit 113 in response to the establishment tag request from the user terminal 100 can be one that enables the user terminal 100 to open a browser window 104 and to link automatically to a website associated with the selected establishment.

As mentioned hereinbefore, execution of the establishment tag command is terminated immediately by the user terminal 100 after the cursor 101 is removed from the selected index point.

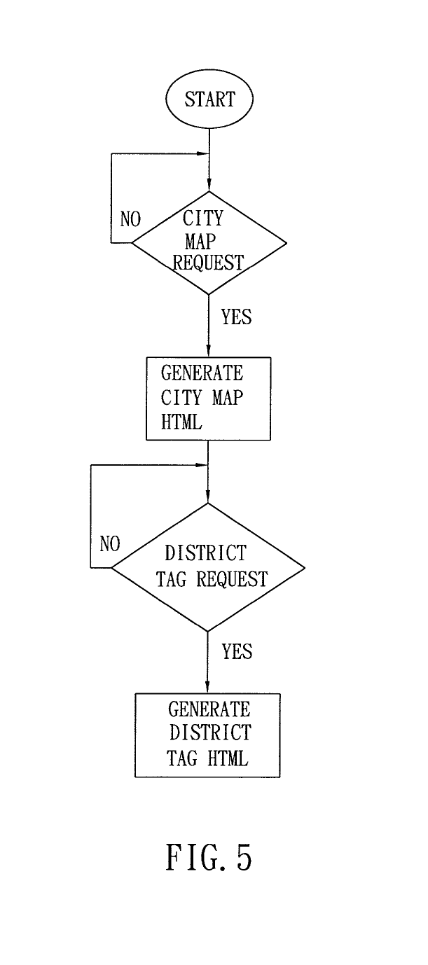

FIG. 5 is a flowchart illustrating how the preferred embodiment enables the user terminal 100 to issue a road map request in accordance with the method and apparatus of the preferred embodiment. With further reference to FIG. 1, the first memory 121 also stores a plurality of city map files, each of which is divided into a plurality of district index regions. Each of the road map files corresponds to one of the district index regions in any one of the city map files. The third memory 123 further stores a district tag command for each of the district index regions. Upon receipt by the first processing unit 111 of a city map request from the user terminal 100, the second processing unit 112 generates city map HTML that is provided to the user terminal 100 so as to enable the latter to display a selected one of the city map files in the first memory 121 in response to the city map request. By configuring each of the district index regions of the city map file with a hyper-link attribute, the city map HTML can further enable the user terminal 100 to issue the road map request upon pointing and clicking at a selected one of the district index regions with the use of a mouse of the user terminal 100 in a conventional manner, and to issue a district tag request to be received by the first processing unit 111 upon detection that the cursor of the user terminal 100 has been resting over any one of the district index regions displayed thereon for a predetermined time period. The third processing unit 113 generates district tag HTML that is provided to the user terminal 100 so as to enable the user terminal to execute the district tag command corresponding to the district tag request received by the first processing unit 111, and to terminate execution of the district tag command when the cursor is removed from said any one of the district index regions.

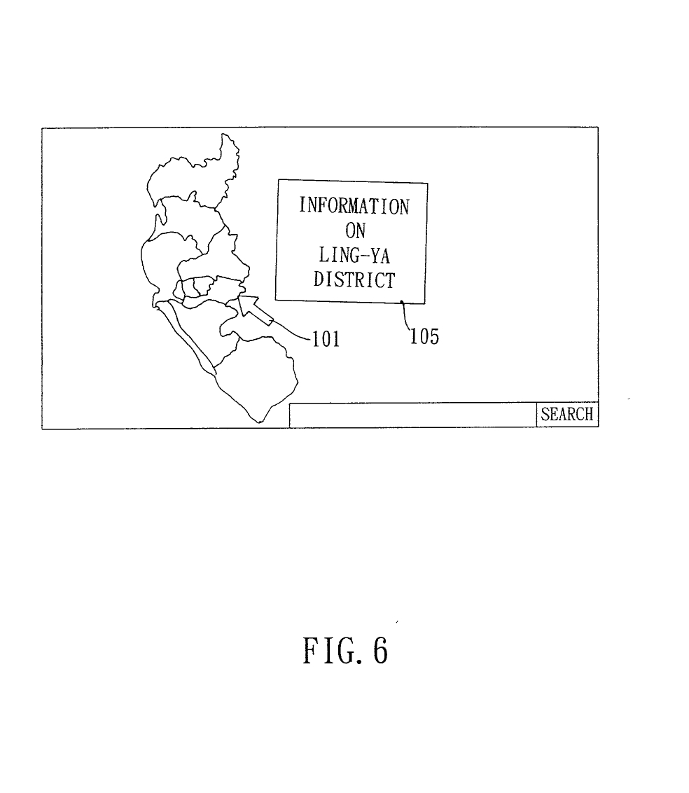

FIG. 6 illustrates the image shown on the user terminal 100 upon receipt of the city map HTML for Kaoshiung City, Taiwan, R.O.C. When the cursor 101 of the user terminal 100 has been resting over the district index region corresponding to “Ling-Ya district” for the predetermined time period, the district tag HTML that is generated by the third processing unit 113 (see FIG. 1) in response to the district tag request from the user terminal 100 (see FIG. 1) enables the user terminal 100 to execute the district tag command for displaying information relevant to “Ling-Ya district”. The information can be in the form of a static or dynamic (scrolling) text file 105 of bibliographic content, or an image file (not shown). Moreover, the district tag HTML that is generated by the third processing unit 113 in response to the district tag request from the user de*r terminal 100 can be one that enables the user terminal 100 to open a browser window (not shown) and to link automatically to a website that has further information on the selected district.

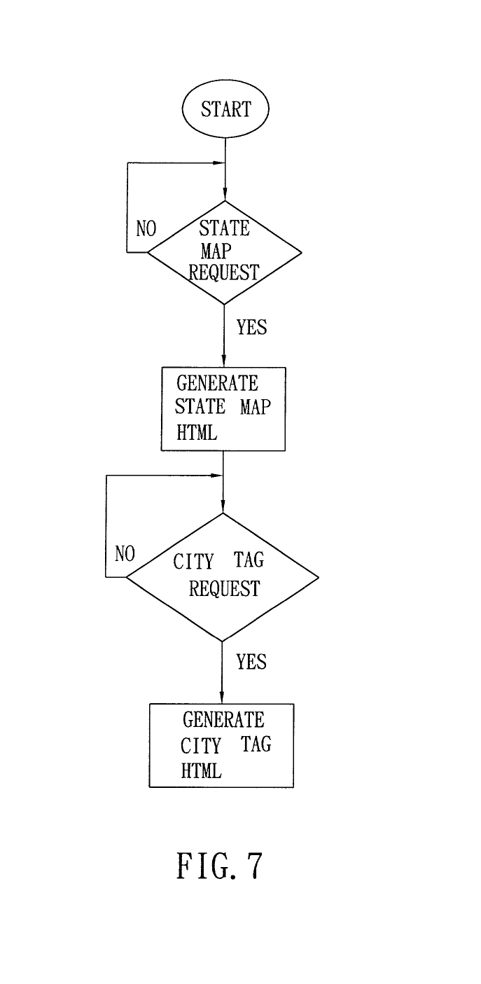

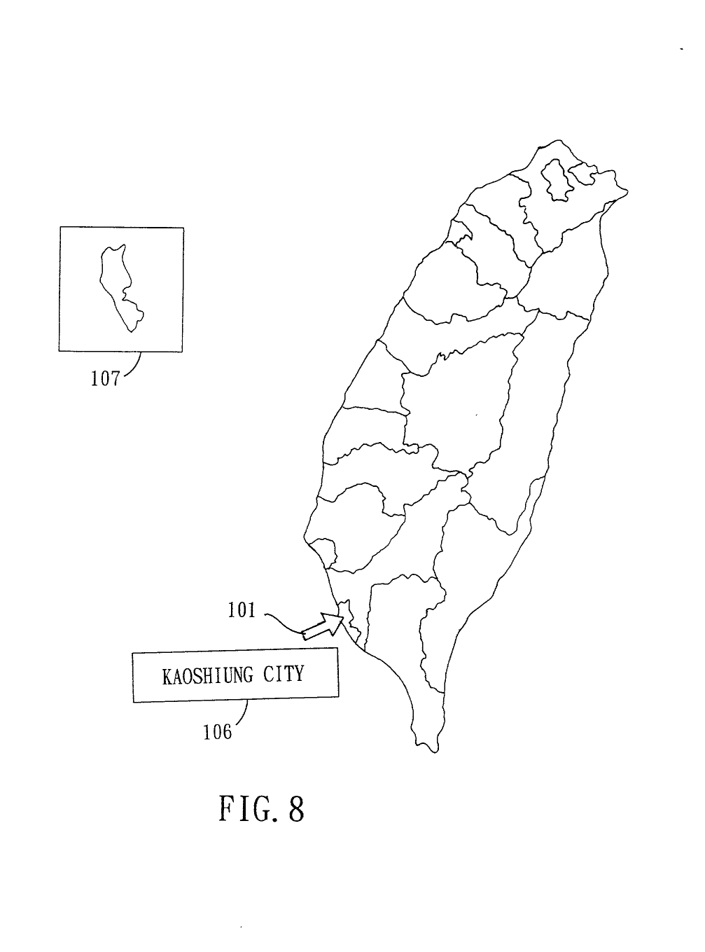

FIG. 7 is a flowchart illustrating how the preferred embodiment enables the user terminal 100 to issue a city map request in accordance with the method and apparatus of the preferred embodiment. With further reference to FIG. 1, the first memory 121 also stores a state map file that is divided into a plurality of city index regions. Each of the city map files corresponds to one of the city index regions. The third memory 123 further stores a city tag command for each of the city index regions. Upon receipt by the first processing unit 111 of a state map request from the user terminal 100, the second processing unit 112 generates state map HTML that is provided to the user terminal 100 so as to enable the latter to display the state map file in response to the state map request. By configuring each of the city index regions of the state map file with a hyper-link attribute, the state map HTML can further enable the user terminal 100 to issue the city map request upon pointing and clicking at a selected one of the city index regions with the use of the mouse of the user terminal 100, and to issue a city tag request to be received by the first processing unit 111 upon detection that the cursor of the user terminal 100 has been resting over any one of the city index regions displayed thereon for a predetermined time period. The third processing unit 113 generates city tag HTML that is provided to the user terminal 100 so as to enable the latter to execute the city tag command corresponding to the city tag request, and to terminate execution of the city tag command when the cursor is removed from said any one of the city index regions.

FIG. 8 illustrates the image shown on the user terminal 100 upon receipt of the state map HTML for Taiwan, R.O.C. When the cursor 101 of the user terminal 100 has been resting over the city index region corresponding to “Kaoshiung City” for the predetermined time period, the city tag HTML that is generated by the third processing unit 113 (see FIG. 1) in response to the city tag request from the user terminal 100 (see FIG. 1) enables the user terminal 100 to execute the city tag command for displaying introductory information relevant to “Kaoshiung City”. The information can be in the form of a static or dynamic (scrolling) text file 106 of bibliographic content, or an image file 107 which presents the user with a major scenic spot of the associated city. Moreover, the city tag HTML that is generated by the third processing unit 113 in response to the city tag request from the user terminal 100 can be one that enables the user terminal 100 to open a browser window (not shown) and to link automatically to a website that has further information on the selected city.

Note that it is within the contemplation of one skilled in the art that, instead of presenting the user with a state map file, the user may be presented with a list of cities. In this manner, the user is able to quickly advance to the desired road map file without going through higher levels of geographical hierarchy.

Some of the advantages of the method and apparatus of this invention are as follows: Establishment data in the method and apparatus of this invention are geographically classified. As such, classification and maintenance of the databases used in the present invention are easier to conduct as compared to the prior art. In addition, because the located establishments are presented in combination with road map files, and because the establishment information are separate from the road map files and are shown only upon receipt of establishment tag HTML, the user is able to browse information of different establishments easily and quickly without incurring a substantial increase in the download time for the road map HTML.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A method for locating geographically classified establishment information, comprising the steps of:
providing a first memory for storing road map files;
providing a second memory for storing establishment data for each of a plurality of establishments that are located in any one of the road map files in the first memory, the establishment data being classified geographically and including map location data that define a location of the corresponding establishment in said any one of the road map files in the first memory;
providing a third memory for storing an establishment tag command for each of the establishments;
in response to a road map request from a user terminal, generating road map HTML that is provided to the user terminal so as to enable the user terminal to display a selected one of the road map files in the first memory corresponding to the road map request and, if any one of the establishment data is encompassed by the selected one of the road map files, to further enable the user terminal to display an index point at the location defined by the map location data of said any one of the establishment data in the selected one of the road map files, the road map HTML further enabling the user terminal to issue an establishment tag request upon detection that a cursor of the user terminal has been resting over any one of the index points displayed thereon for a predetermined time period; and
in response to the establishment tag request, generating establishment tag HTML that is provided to the user terminal so as to enable the user terminal to execute the establishment tag command corresponding to the establishment tag request, and to terminate execution of the establishment tag command when the cursor is removed from said any one of the index points.

2. The method of claim 1, wherein the establishment tag command allows the user terminal to display establishment information corresponding to said any one of the index points upon execution.

3. The method of claim 2, wherein the establishment information is a text file.

4. The method of claim 2, wherein the establishment information is an image file.

5. The method of claim 1, wherein the establishment tag command enables the user terminal to open a browser window and to link automatically to a website of the establishment that corresponds to said any one of the index points upon execution.

6. The method of claim 1, wherein said first memory further stores a plurality of city map files, each of which is divided into a plurality of district index regions, each of the road map files corresponding to one of the district index regions in any one of the city map files, said method further comprising the step of:
in response to a city map request from the user terminal, generating city map HTML that is provided to the user terminal so as to enable the user terminal to display a selected one of the city map files in the first memory corresponding to the city map request, the city map HTML further enabling the user terminal to issue the road map request upon pointing and clicking at a selected one of the district index regions.

7. The method of claim 6, wherein said third memory further stores a district tag command for each of the district index regions, the city map HTML further enabling the user terminal to issue a district tag request upon detection that the cursor of the user terminal has been resting over any one of the district index regions displayed thereon for a predetermined time period, said method further comprising the step of:
in response to the district tag request, generating district tag HTML that is provided to the user terminal so as to enable the user terminal to execute the district tag command corresponding to the district tag request, and to terminate execution of the district tag command when the cursor is removed from said any one of the district index regions.

8. The method of claim 6, wherein said first memory further stores a state map file divided into a plurality of city index regions, each of the city map files corresponding to one of the city index regions, said method further comprising the step of:
in response to receive a state map request from the user terminal, generating state map HTML that is provided to the user terminal so as to enable the user terminal to display the state map file, the state map HTML further enabling the user terminal to issue the city map request upon pointing and clicking at a selected one of the city index regions.

9. The method of claim 8, wherein said third memory further stores a city tag command for each of the city index regions, the state map HTML further enabling the user terminal to issue a city tag request upon detection that the cursor of the user terminal has been resting over any one of the city index regions displayed thereon for a predetermined time period, said method further comprising the step of:
in response to the city tag request, generating city tag HTML that is provided to the user terminal so as to enable the user terminal to execute the city tag command corresponding to the city tag request, and to terminate execution of the city tag command when the cursor is removed from said any one of the city index regions.

10. The method of claim 1, wherein the establishment data in the second memory are further classified into topics according to type of service offered by the corresponding establishment, the road map HTML enabling the user terminal to display the index point at the location defined by the map location data of said any one of the establishment data that is encompassed by both the selected one of the road map files and the topic defined by a topic search request from the user terminal.

11. The method of claim 1, wherein the first, second and third memories reside in a computer network that is accessible to the user terminal.

12. The method of claim 11, wherein the computer network is the internet.

13. An apparatus for locating geographically classified establishment information, comprising:
a first memory for storing road map files;
a second memory for storing establishment data for each of a plurality of establishments that are located in any one of the road map files in the first memory, the establishment data being classified geographically and including map location data that define a location of the corresponding establishment in said any one of the road map files in the first memory;
a third memory for storing an establishment tag command for each of the establishments;
a first processing unit adapted to receive a road map request from a user terminal;
a second processing unit adapted to generate road map HTML that is provided to the user terminal so as to enable the user terminal to display a selected one of the road map files in the first memory corresponding to the road map request and, if any one of the establishment data is encompassed by the selected one of the road map files, to further enable the user terminal to display an index point at the location defined by the map location data of said any one of the establishment data in the selected one of the road map files, the road map HTML further enabling the user terminal to issue an establishment tag request to be received by the first processing unit upon detection that a cursor of the user terminal has been resting over any one of the index points displayed thereon for a predetermined time period; and
a third processing unit adapted to generate establishment tag HTML that is provided to the user terminal so as to enable the user terminal to execute the establishment tag command corresponding to the establishment tag request, and to terminate execution of the establishment tag command when the cursor is removed from said any one of the index points.

14. The apparatus of claim 13, wherein the establishment tag command allows the user terminal to display establishment information corresponding to said any one of the index points upon execution.

15. The apparatus of claim 14, wherein the establishment information is a text file.

16. The apparatus of claim 14, wherein the establishment information is an image file.

17. The apparatus of claim 13, wherein the establishment tag command enables the user terminal to open a browser window and to link automatically to a website of the establishment that corresponds to said any one of the index points upon execution.

18. The apparatus of claim 13, wherein:
said first memory further stores a plurality of city map files, each of which is divided into a plurality of district index regions, each of the road map files corresponding to one of the district index regions in any one of the city map files;
said first processing unit being further adapted to receive a city map request from the user terminal;
said second processing unit being further adapted to generate city map HTML that is provided to the user terminal so as to enable the user terminal to display a selected one of the city map files in the first memory corresponding to the city map request, the city map HTML further enabling the user terminal to issue the road map request upon pointing and clicking at a selected one of the district index regions.

19. The apparatus of claim 18, wherein:
said third memory further stores a district tag command for each of the district index regions;
the city map HTML further enabling the user terminal to issue a district tag request to be received by the first processing unit upon detection that the cursor of the user terminal has been resting over any one of the district index regions displayed thereon for a predetermined time period;
said third processing unit being further adapted to generate district tag HTML that is provided to the user terminal so as to enable the user terminal to execute the district tag command corresponding to the district tag request, and to terminate execution of the district tag command when the cursor is removed from said any one of the district index regions.

20. The apparatus of claim 18, wherein:
said first memory further stores a state map file divided into a plurality of city index regions, each of the city map files corresponding to one of the city index regions;
said first processing unit being further adapted to receive a state map request from the user terminal;
said second processing unit being further adapted to generate state map HTML that is provided to the user terminal so as to enable the user terminal to display the state map file in response to the state map request, the state map HTML further enabling the user terminal to issue the city map request upon pointing and clicking at a selected one of the city index regions.

21. The apparatus of claim 20, wherein:
said third memory further stores a city tag command for each of the city index regions;
the state map HTML further enabling the user terminal to issue a city tag request to be received by the first processing unit upon detection that the cursor of the user terminal has been resting over any one of the city index regions displayed thereon for a predetermined time period;
said third processing unit being further adapted to generate city tag HTML that is provided to the user terminal so as to enable the user terminal to execute the city tag command corresponding to the city tag request, and to terminate execution of the city tag command when the cursor is removed from said any one of the city index regions.

22. The apparatus of claim 13, wherein:
the establishment data in the second memory are further classified into topics according to type of service offered by the corresponding establishment;
said first processing unit being further adapted to receive a topic search request from the user terminal;
the road map HTML enabling the user terminal to display the index point at the location defined by the map location data of said any one of the establishment data that is encompassed by both the selected one of the road map files and the topic defined by the topic search request.

23. A program product stored on a computer readable storage medium comprising code means adapted to carry out the method steps of the method of claim 1.
